(19) United States
(12) Patent Application Publication
(10) Pub. No.: US 2014/0075583 A1
(43) Pub. Date: Mar. 13, 2014

(54) MANAGEMENT OF MEDIA ITEMS

(71) Applicants: Timothy B. Martin, Sunnyvale, CA (US); Christopher John Sanders, San Jose, CA (US); Christopher Robert Wysocki, Los Gatos, CA (US); Jeffrey L. Robbin, Los Altos, CA (US); David K. Heller, Los Altos, CA (US)

(72) Inventors: Timothy B. Martin, Sunnyvale, CA (US); Christopher John Sanders, San Jose, CA (US); Christopher Robert Wysocki, Los Gatos, CA (US); Jeffrey L. Robbin, Los Altos, CA (US); David K. Heller, Los Altos, CA (US)

(73) Assignee: Apple Inc., Cupertino, CA (US)

(21) Appl. No.: 13/609,221

(22) Filed: Sep. 10, 2012

(51) Int. Cl. G06F 21/00; G06F 15/16

(52) U.S. Cl. 726/31; 726/26; 709/217

(57) ABSTRACT

Disclosed herein are systems, methods, and non-transitory computer-readable storage media for making policy decisions relating to when to sync and when to default to cloud storage and for addressing the need for solutions relating to how to share media items between overlapping user accounts

### BACKGROUND

1. Technical Field

The present disclosure relates to sharing and transferring media items and more specifically to systems for transferring media in a cloud-based storage model.

2. Introduction

The sharing and consumption of digital media has become a nearly ubiquitous part of modern society. Likewise, digital media playback applications are available on an ever-increasing amount of devices. This growth has created legal and technological dilemmas.

A major legal dilemma concerns the sharing of digital media between users and devices and creates issues concerning rights to revenue and post-sale artistic control. Indeed, peer-to-peer digital file sharing applications have been especially controversial. Attempted solutions to the issue of file-sharing include the development of digital rights management technology aimed to thwart unwanted and illegal file-sharing. Additionally, legislation that has been enacted that creates civil and criminal liability for unauthorized transfer of digital media.

With respect to technological issues, a major concern is that the types of digital media available for consumption can comprise large file sizes and can quickly consume the finite storage resources typically available on user devices. With respect to this issue of limited memory resources, many hardware, software, and system architecture solutions have been proposed. For example, a successful home library model has been developed that stores a library of digital media onto dedicated, resource-rich devices and transfers a portion of the media items to other resource-constrained devices. Additionally, network-based storage of media items, or “cloud” storage, along with methods for re-downloading and streaming digital media to user devices, have relieved the issue of limited memory resources on client devices.

However, when the proposed solutions to the various issues in the fields of storage and distribution of digital media are implemented in a same system or device, such solutions can conflict. For example, automatically transferring or syncing digital media from one device to another can obscure the convenience and benefit offered by network-based storage models. Similarly, some digital rights management policies prevent certain media types from being re-downloaded or streamed from a network-based storage facility. Consequently, solutions are needed to provide an efficient file transferring system that fits well into a cloud-centric storage paradigm. Also, solutions are needed to allow users to share digital media between devices associated with overlapping user accounts.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods and non-transitory computer-readable media that make policy decisions relating to when to sync media items to a computer device and when to default to saving the media items in cloud storage. Also, some embodiments of the present technology address the need for solutions relating to how to share media items between overlapping user accounts.

Some embodiments of the present technology involve systems, methods, and computer-readable media configured for obtaining a list of media items stored at a first device and that are available to transfer to a second device upon the first device being operatively coupled with the second device, determining which of the media items in the list are not available for re-download from cloud storage, and syncing the media items that cannot be re-download.

Some embodiments of the present technology further involve systems, methods, and computer-readable media configured for determining which of the media items in the list are not available for re-download from another source by comparing media items stored on the first device with media items stored in cloud storage and determining if media items on the list of media items that are stored on the first device, but not in cloud storage comply with a digital rights management policy.

Some embodiments of the present technology involve enhanced transferring techniques in a system including: a server with an online storage component configured for storing media items associated with a user account; a media distribution and management system configured for distributing media items to a client device associated with a user account; and a computer having a client application associated with one or more user account. In some embodiments, the server: receives a list of media items that might need to be synced when a first device is operatively coupled with the second device. The server also compares media items stored on the first device with media items stored in the online storage component, and receives a list of media items that are stored on the first device, but not in the online storage component.

Some embodiments of the present technology involve a server with an online storage component configured for transferring media from a first device to a second device. In some embodiments the server associates the first device and the second device with one or more user account eligible for overlapping between the first device and the second device and receives a request by a first device to transfer a media item to the second device. The second device determines if the first device is associated with an overlapping user account, and if so, transfers the media item to the second device. In some embodiments, the server determines if the first device is associated with an overlapping user account as the second device by examining a first media library associated with a media player client application on the first device, examining a second media library associated with a media player client application on the second device, and determining if the first media library and the second media library share common user account library folders.

Some embodiments of the present technology involve associating a first device with a first user account, operatively coupling the first device with a second device associated with second user account, the second user account associated with a media library containing a media item, receiving an authorization from an online media platform managing the first user account to add the media item to the first device, and accepting the transfer of a copy of the media item to the first device from the media library of the second device.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a system for improved media item transfer according to some embodiments of the present technology;

FIG. 2 illustrates a method of determining if media items are available for re-download and transferring media items between devices according to some embodiments of the present technology;

FIG. 3 illustrates an exemplary interface for transferring media items from a home computer to a second device according to some embodiments of the present technology;

FIG. 4 illustrates an interface and a dialog providing advanced sync controls according to some embodiments of the present technology;

FIG. 5 illustrates an exemplary interface and interface feature for requesting the transfer of media items to an operatively coupled device according to some embodiments of the present technology;

FIG. 6 illustrates an exemplary interface for manually requesting the transfer of media items to an operatively coupled device according to some embodiments of the present technology;

FIG. 7 illustrates an example of an interface with dialog prompt in a home library pairing model according to some embodiments of the present technology;

FIG. 8 illustrates a system for transferring media items between a non-home computer and a device associated with a home computer according to some embodiments of present technology;

FIG. 9 illustrates a method of transferring media items between a non-home computer and a device associated with a home computer according to some embodiments of present technology;

FIG. 10 illustrates an exemplary computer system for implementing the present technology according to some embodiments of the present technology; and

FIG. 11 illustrates an exemplary cloud-computing system for implementing the present technology according to some embodiments of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present technology addresses the need in the art for a file transferring system that fits well into a cloud-centric storage paradigm. Indeed, some embodiments of the present technology involve systems, methods, and non-transitory computer-readable media that make policy decisions relating to when to sync and when to default to cloud storage. Also, some embodiments of the present technology address the need for solutions relating to how to share media items between overlapping user accounts.

For the purpose of this disclosure, the term “device” shall include desktop computers, laptop personal computers, tablet devices, personal digital assistants, portable music players, mobile phones, smartphones, servers, virtual machines, online cloud storage locations, and other computing products configured to store or playback digital media. For the purpose of this disclosure, the term “transfer” shall include: moving media items, from a first device to a second device; copying media items on a first device, storing a copy of the media items on the second device, and retaining the copies of the media items on the first device; and combinations thereof. For the purpose of this disclosure, the terms “sync,” “synced,” and “syncing” shall include automatically or manually transferring one or more media items from a first device to a second device upon operatively coupling the first device to the second device.

Media items can include a wide variety of files including, but not limited to owned, licensed, and rented digital music files, music albums, playlists, compilations, movies, television shows, eBooks, audiobooks, newspapers, magazines, web browsing bookmarks, user preference data, audio podcasts, video podcasts, software applications (i.e. “apps”), documents, etc.

The present technology can be implemented in a wide variety of scenarios that involve the sharing of media items. For example, the present technology can be implemented in the context of a media distribution and management system, such as the iTunes® store, available from Apple Inc. of Cupertino, Calif. Additionally, the present technology can be implemented in a commercial, educational, industrial, governmental, or mixed-use scenarios when a system operator wants to control how media items are purchased, rented, leased, checkout, shared, transferred, synced, downloaded, redownloaded, etc.

In the case of media items being obtained and consumed by consumer devices, a media player application can be configured for playing, downloading, saving, and organizing digital media on supported devices, now known or later developed. The term “media player” should not be construed to limit its function to playing media items. For example, the media player application can also edit, modify, and manage media items, The media player application can also establish and manage user accounts on the supported devices and can coordinate media transfer and sharing between the devices associated with the user accounts. The media player application can also coordinate the transfer of media items to other user devices and to cloud-based servers for providing cloud-based storage solutions and cloud-based services delivery, such as iCloud®, available from Apple Inc. of Cupertino, Calif. Cloud-computing systems are explained in greater detail below.

As explained above, syncing media items from one device to another device provides a high degree of convenience. However, in some cloud-based models for storing and delivering media items, the automatic transfer of media from one device to another device can unnecessarily consume the finite storage resources of the other device since the media is already being preserved in cloud-based storage. Nevertheless, in some cases, media items cannot be downloaded on a first device, stored in a cloud-based storage system, and later re-downloaded by a second device.

For example, many publishers of electronic books and audiobooks employ digital rights management (“DRM”) policy that excludes an electronic book or audiobook from being re-downloaded, but that allows the electronic book or audiobook to be transferred to another device. Consequently, some embodiments of the present technology involve determining a list of media items that might need to be transferred from a first device to a second device in order to preserve the media item on the second device in the cases where the media items cannot be re-downloaded.

In another example, systems operators in a business or other commercial context can employ access controls that limit what types of documents can be obtained by members of an enterprise. Accordingly, some embodiments of the present technology involve determining a list of media items that can be accessed in an enterprise. Likewise, some embodiments of the present technology involve versioning controls in an enterprise and determining a list of media items that can be obtained in read-only or editable forms. Similarly, some embodiments of the present technology can involve determining a list of media items that cannot be transferred, e.g. in the context of enforcing legal holds.

In some embodiments of present technology, a network-based media distribution and management system, or its related local client application, are configured to obtain a determination relating to whether to transfer media items between devices, whether to store media items in a cloud-based storage facility by accessing one or more online processing modules, or whether to do a combination of transferring and cloud-based storing.

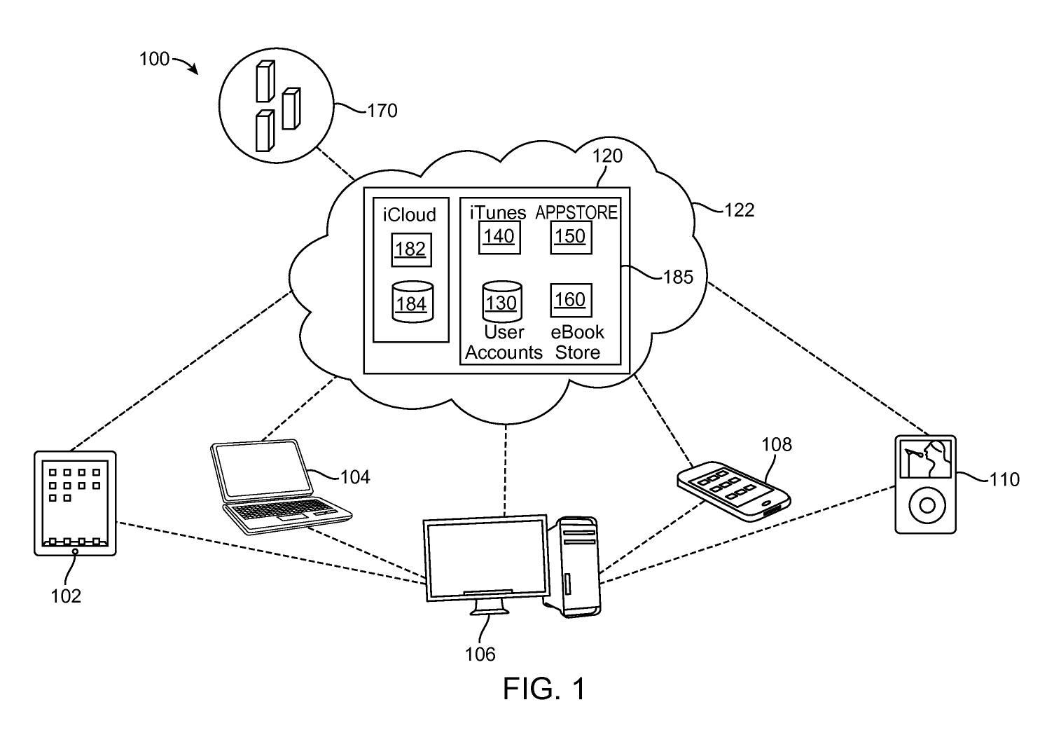

FIG. 1 illustrates a system 100 for improved media item transfer according to some embodiments of the present technology. The system 100 comprises a plurality of computing devices 102, 104, 106, 108, 110 coupled with a network-based media platform 120 via one or more networks 122. In some embodiments of the present technology, the media platform 120 comprises one or more processing modules for performing the present technology as broadly disclosed herein. In some embodiments of the present technology, the media platform comprises one or more media distribution systems 185 associated with a database 130 of user accounts.

In particular embodiments of the present technology, the one or more media distribution systems comprise a media distribution and management system 140, such as the iTunes® store, available from Apple Inc. of Cupertino, Calif.

In some embodiments of the present technology, the one or more media distribution systems comprise an eBook distribution and management system 160, such as iBookstrore^{SM}, available from Apple Inc. of Cupertino, Calif. In some embodiments of the present technology, the one or more media distribution systems comprise an application distribution and management system 150, such as App Store^{SM}, available from Apple Inc. of Cupertino, Calif.

In some embodiments of the present technology, the computing devices 102, 104, 106, 108, 110 include a media player computer program used for presenting, downloading, saving, and organizing digital media items, such as an iTunes® client for computers and mobile devices, available from Apple Inc. of Cupertino, Calif.

In some embodiments of the present technology, the media platform 120 also comprises a cloud storage component 180, such as iCloud™, available from Apple Inc. of Cupertino, Calif. In some embodiments, the cloud storage component 180 comprises a processing module 182 and a storage component 184. A cloud storage component 180 of a media platform 120 can allow users to store digital media items remotely and can make the stored digital media available for re-download, thereby allowing the users to retain access to the media, but not requiring that they store the media on a device itself. However, as explained above, some digital media items are subject to digital rights management policies that exclude it from legally or practically being re-downloaded. To enforce the DRM policies, some embodiments of the present technology involve the system 100 including one or more access control servers 170.

In some embodiments of the present technology, the one or more access control servers 170 enforce policies related to limiting the amount of access users have to media items. For example, in some embodiments of the present technology, the access control servers 170 enforce digital rights management policies which control or limit access to digital media after the media is sold, rented, or licensed.

As explained herein, the system 100 of FIG. 1 is configured to facilitate and manage the transfer of media items from the media platform 120 to one or more of the computing devices 102, 104, 106, 108, 110 when the media items are not re-downloadable—as determined by the access control servers.

The architecture illustrated in FIG. 1 is exemplary and a wide variety of other architectures can be configured to carry out the advantages of the present technology. For example, in some embodiments, the access control mechanisms can be integrated into a media distribution platform, client devices, peripheral devices, etc.

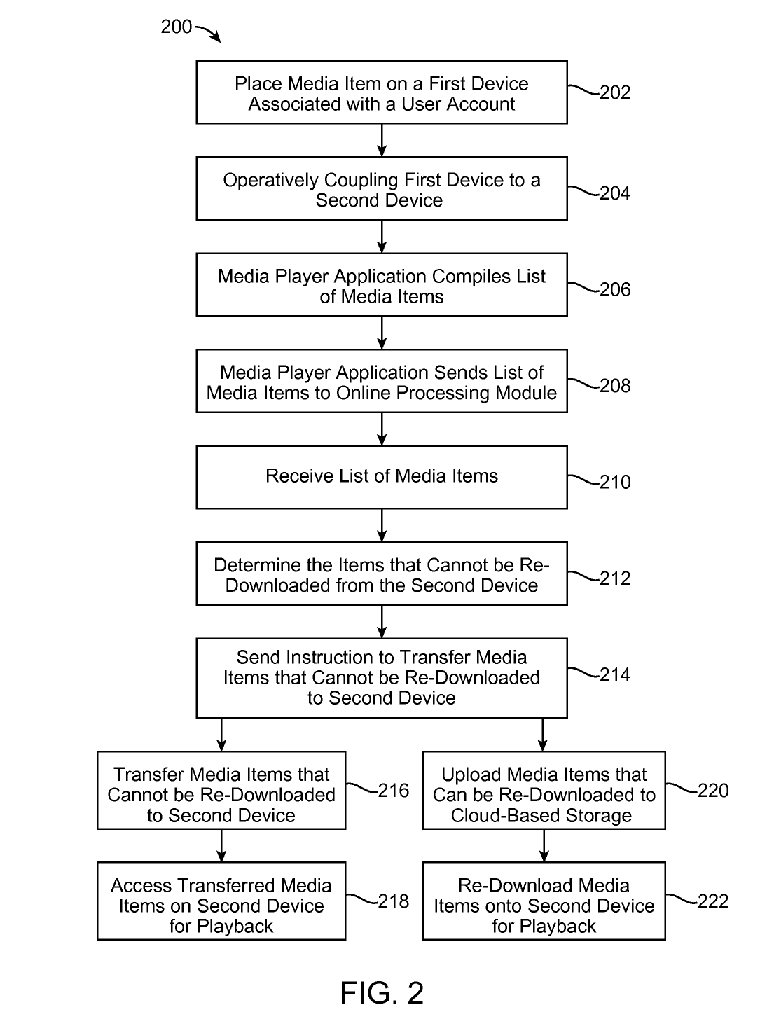

FIG. 2 illustrates a method of determining if media items are not available for re-download and transferring media items between devices according to some embodiments of the present technology. As illustrated in FIG. 2, the method 200 involves placing one or more media items on a first device that is associated with a user account (step 202). In some embodiments of the present technology, placing one or more media items on a device comprises purchasing and downloading the one or more media items from a media distribution and management system, such as iTunes®, available from Apple Inc. of Cupertino, Calif. In some embodiments of the present technology, placing one or more media items on a device comprises re-downloading the one or more media items from a cloud-based media storage system, such as iCloud®, available from Apple Inc. of Cupertino, Calif. In some embodiments of the present technology, placing one or more media items on a device comprises re-downloading the one or more media items from another client device.

Next, the first device is operatively coupled with a second device (step 204). In some embodiments, the first device and the second device are physically coupled via a wireline connection, using one or more cables or connectors, e.g. USB to dock connection. In some embodiments, the first device and the second device are wirelessly coupled using various wireless technologies (e.g. cellular, Wi-Fi, or Bluetooth). Upon operatively coupling the devices, a media player application compiles a list of media items on the first device (step 206) and sends the list to a network-based media platform (step 208). The compilation of a list of media items can occur automatically or in response to a user command. The network-based media platform receives a list of items from the first device (step 210) and determines which items cannot be re-downloaded on to a second device (step 212). In some embodiments of the present technology, the network-based media platform consults one or more digital rights management servers to determine if the media items can be re-downloaded.

Once a determination is made relating to whether the media items can or cannot be re-downloaded, the network-based media platform sends an instruction to the first device, the second device, or both the first device and second device to transfer media items that cannot be re-downloaded from the first device to the second device (step 214).

Next, media items that cannot be re-downloaded are transferred to the second device (step 216) and accessed on the second device for playback (step 218). Likewise, media items that can be re-downloaded are uploaded to a cloud-based storage system (step 220) and re-downloaded onto the second device for subsequent playback (step 222).

As explained above, the present technology can save finite storage resources on devices preserving re-downloadable media items in cloud-based storage rather than automatically syncing all media items to a resource-constrained device. However, according to some embodiments of the present technology, users can still manually transfer media items to a device. Indeed, some embodiments of the present technology involve interface features that provide users with intuitive controls for manually transferring media items.

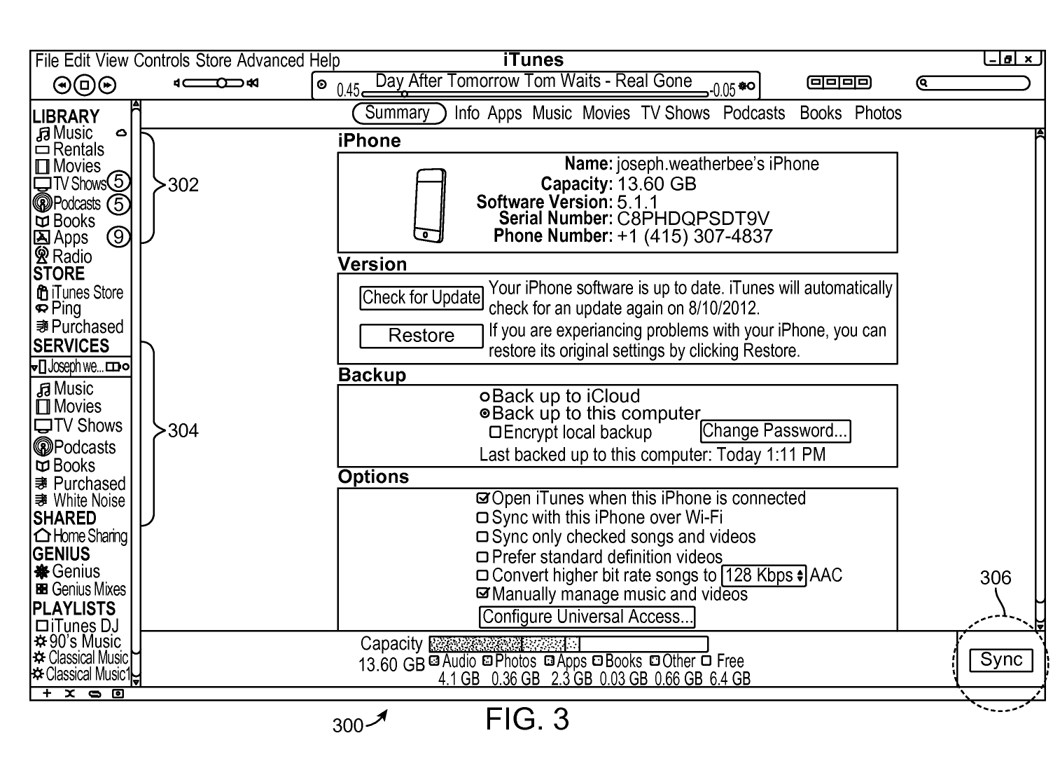

FIG. 3 illustrates an exemplary interface 300 for transferring media items from a home computer to a second device according to some embodiments of the present technology. The interface 300 of FIG. 3 includes a “Library” frame 302 listing media item categories containing media items contained in a computer's media library that is associated with one or more user accounts as well as media items associated with a user's account that is stored in a cloud-based media storage system. The interface 300 also includes a “Devices” frame 304 showing devices that are currently operatively coupled with the computer. As explained above, some embodiments of the invention involve syncing devices. Accordingly, the interface 300 includes a “Sync” command 306 for initiating a process of determining what media items to automatically transfer to the operatively coupled devices. In some embodiments of the present technology, syncing automatically occurs upon a device being operatively coupled with the computer. However, as explained above, storage constraints and cloud-based alternatives discourage users from storing media items locally on a device. Therefore, some embodiments of the present technology involve an interface for providing advanced auto-sync controls.

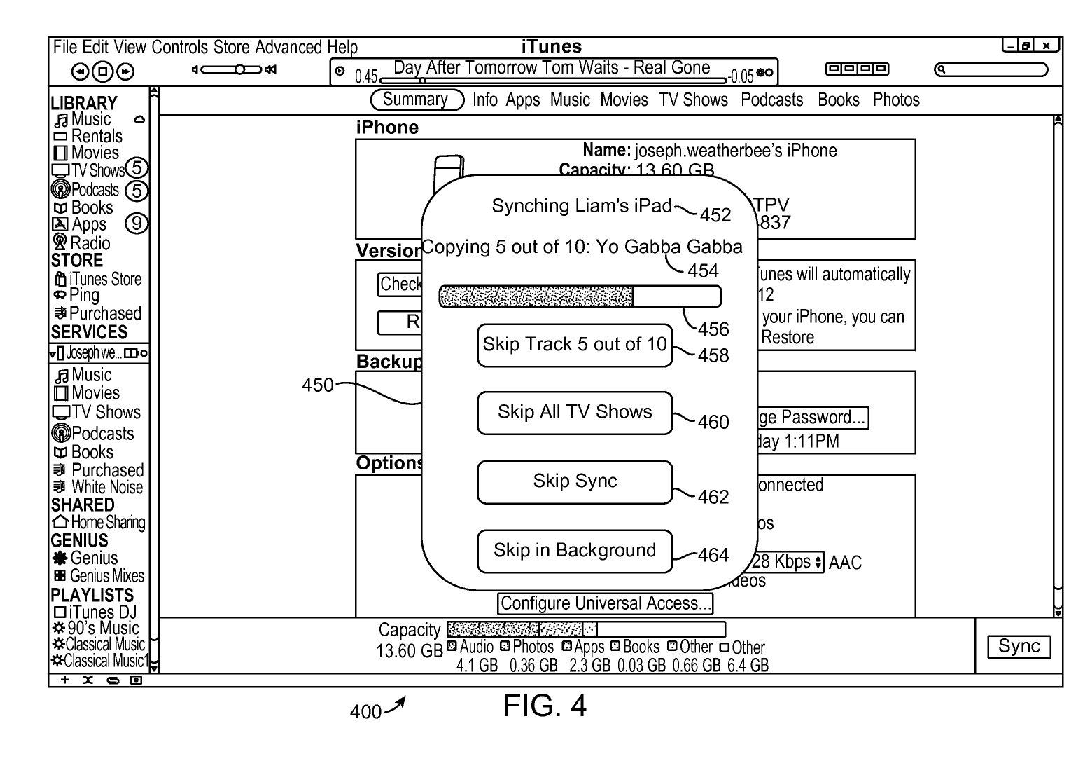

FIG. 4 illustrates an interface 400 and a dialog 450 providing advanced sync controls according to some embodiments of the present technology. The dialog 450 can include identification 452 of the device, a description 454 of the sync actions being performed, and a progress bar 456. The dialog 450 can also include: an interactive button 458 for commanding the media player client to skip a particular media item from syncing, an interactive button 460 for commanding the media player client to skip a subset of media items from syncing, and interactive button 462 for commanding the media player client to forego the entire sync process, and an interactive button 464 for commanding the media player client to sync certain media items (e.g. all media, all songs, eBooks only, etc.), but to do so in the background.

As mentioned above, in the case of an entire library of media items being backed up in cloud-based storage, many users will chose to forego actually transferring media to a device in favor of re-downloading or streaming the media to other devices. However, many users will also want the option of actually transferring media items to a device. For example, users who plan on being without access to cloud-based storage (e.g. airplane travelers) might want to load their portable device with media items. Accordingly, some embodiments of the present technology involve the media player client application having interface features for facilitating media item transfer.

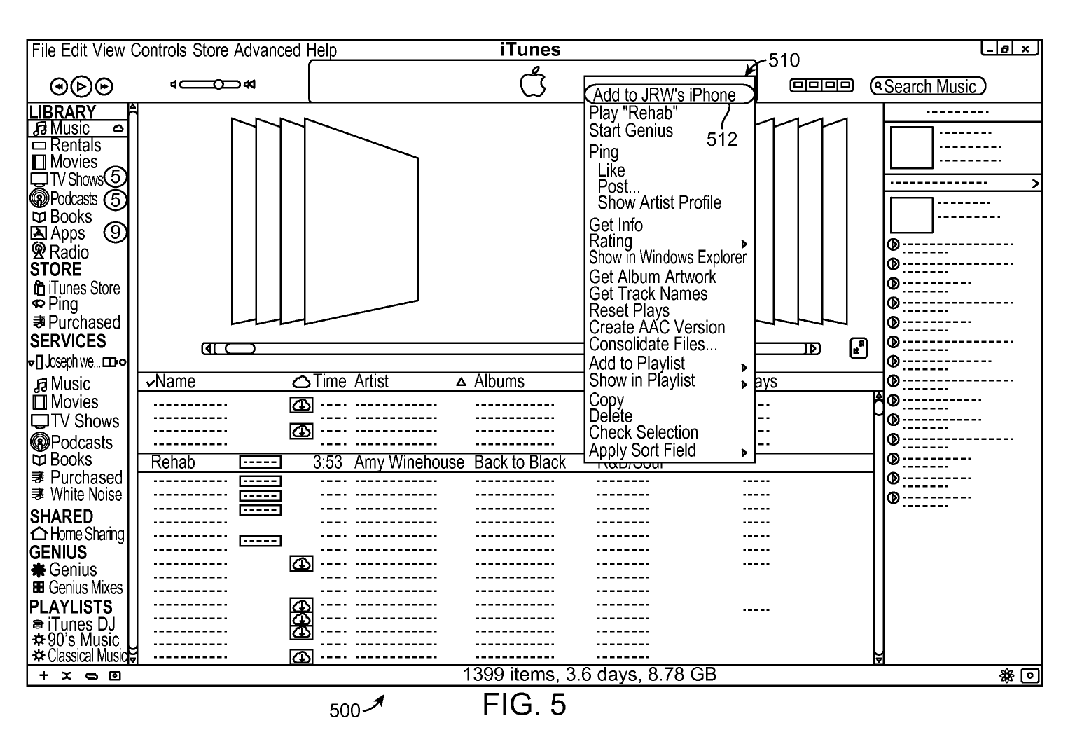

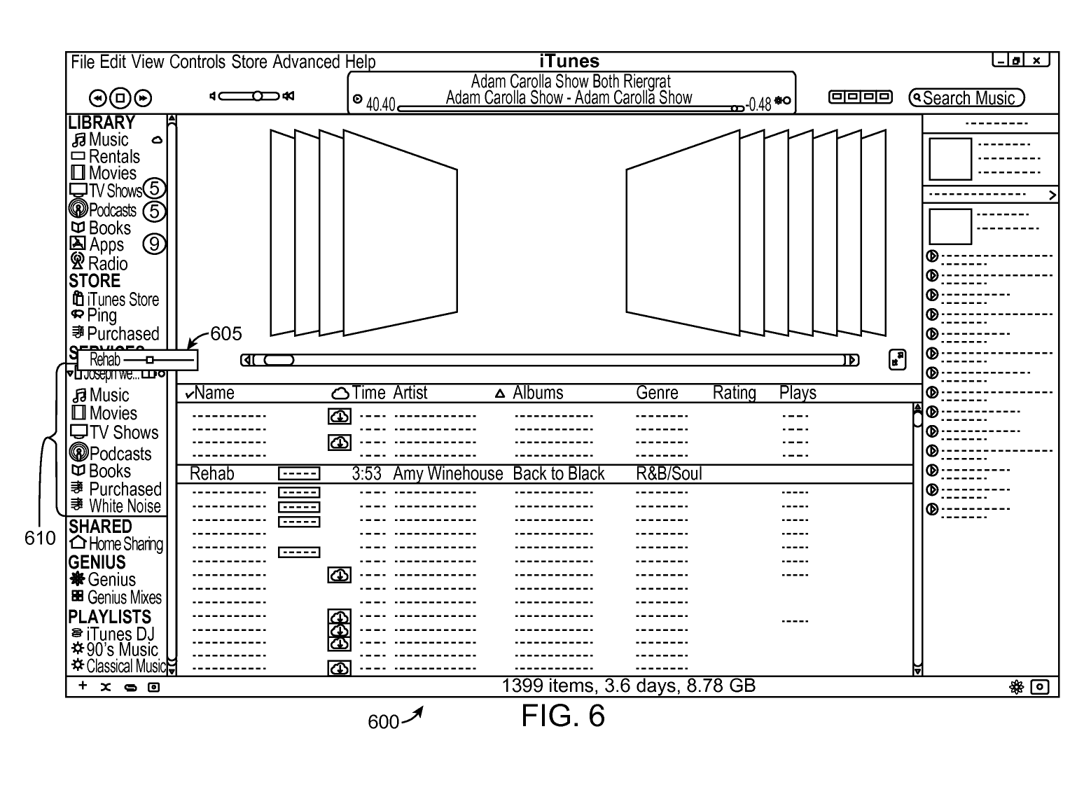

FIG. 5 illustrates an exemplary interface 500 and interface menu feature 510 for requesting the transfer of media items to an operatively coupled device according to some embodiments of the present technology. As illustrated in FIG. 5, an interface menu feature 510 configured for manually requesting the transfer of media items comprises an “Add To” command 512. FIG. 6 illustrates an exemplary interface 600 for manually requesting the transfer of media items to an operatively coupled device according to some embodiments of the present technology. As illustrated in FIG. 6, requesting the transfer of media items comprises dragging a virtual representation of one or more media items 605 to a device frame 610, thereby instructing that the media player client application transfer the dragged items to the operatively coupled device.

In some embodiments of the present technology, a media distribution and management system 140 maintains user accounts and associates user accounts with particular computing devices. For example, in some embodiments of the present technology, the media distribution and management system 140 limits a user account to a particular number of authorized devices. In some of these embodiments, users can indicate one authorized device as their “home” device and decisions can be made relating to syncing media, transferring media, and storing media in a cloud-based storage facility based on whether or not a device is operatively coupled with a “home” device or “non-home” device. For the purpose of this disclosure, the use of the term “home” should not be taken to imply the use of the machine exclusively at a user's home; rather, use of the term “home” shall simply mean that the “home” device received a “home” designation. Similarly, the term “non-home” should not be read to imply that a “non-home” cannot be used in a home; rather, the term “non-home” shall simply refer to a device that has not received a “home” designation.

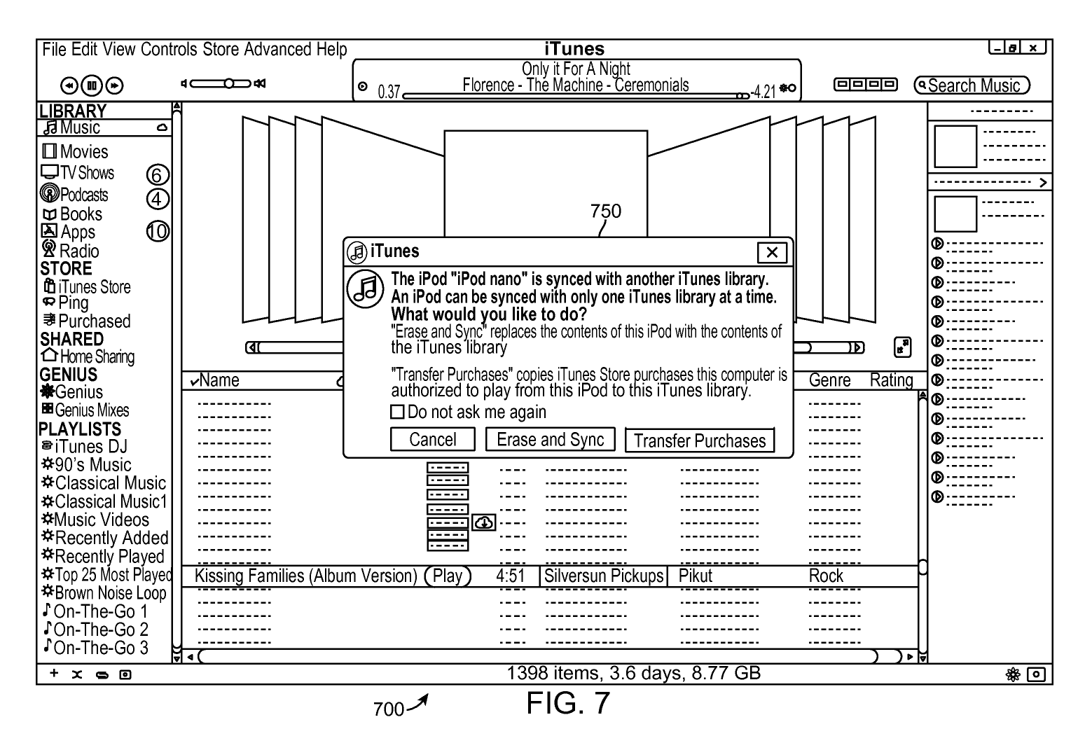

In a typical configuration, operatively coupling a device associated with a user account to a non-home computer having a media distribution and management system client installed thereon causes the non-home computer to prompt the user with a dialog asking if the user wants to change the “home” designation of the coupled computer. FIG. 7 illustrates an example of an interface 700 with dialog prompt 750 in a home library pairing model according to some embodiments of the present technology. As illustrated in FIG. 7, the dialog prompt 750 allows a user to either: erase the media on the device and sync with the new, previously-non-home computer; transfer authorized media items to the non-home computer; or cancel the sync attempt. The interface illustrated in FIG. 7 does not allow transferring of media items from a non-home computer to a device.

However, some embodiments of the present technology involve allowing the transfer of media items from a non-home computer to a device associated with a home computer under certain circumstances. In particular, the present technology allows for such a transfer to occur if the home computer and non-home computer are each associated with sets of user accounts, and associated libraries, that are overlapping. That is, the set of user accounts for the home computer and the set of user accounts for the non-home computer have at least one user account in common, Therefore, in some embodiments of the present technology, a media distribution and management system allows the transfer of media items from a non-home computer to a device associated with a home computer if the non-home computer contains a media library associated with a user account and the media library on the home computer also contains at least one media library associated with the same user account.

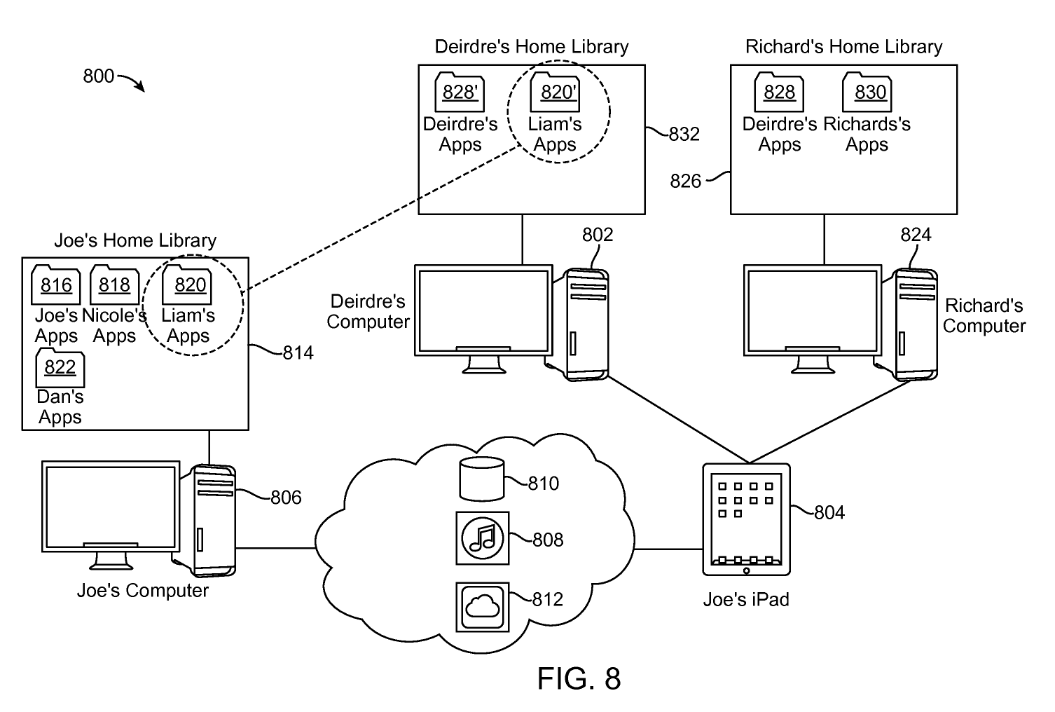

FIG. 8 illustrates a system 800 for transferring media items between a non-home computer 802 and a device 804 associated with a home computer 806 according to some embodiments of present technology. As illustrated in FIG. 8, the home computer 806 is operatively coupled with a network-based media distribution and management system 808. In some embodiments of the present technology, the media distribution and management system 808 allows the computer to be associated with a certain number of user accounts (e.g. five accounts) and the accounts have a media library on the associated computers. As illustrated in FIG. 8, the home computer 806 includes a media library 814 of folders 816, 818, 820, 822 containing media items for a plurality of user accounts. The network-based media distribution and management system 808 also includes a user account database 810 for storing information about user accounts as well as a cloud storage component 812. In some embodiments, the media distribution and management system 808 stores the identity of the device's home computer. For example, the media distribution and management system 808 can identify the home computer 806 of the device 804.

The device 804 can operatively couple one or more non-home computers. As illustrated, the device 804 is operatively coupled with non-home computer 802 and non-home computer 824. Non-home computer 824 is associated with a media library 826 containing folders 828, 830 that are associated with two user accounts. The two user accounts associated with the non-home computer 824 do not overlap with any of the accounts associated with the home computer 814.

Non-home computer 802 contains a media library 826 containing folders 828′, 820′ that are associated with the two user accounts. A user account associated with the non-home computer 802 does overlap an account associated with the home computer 814. As illustrated folder 820 and folder 820′ constitute media item folders for the same user account. Therefore, according to some embodiments of the present invention, the media distribution and management system 808 will allow the manual transfer of media items from the non-home computer 802 to the device 804. In some embodiments, only media items from the folder 820′ can be transferred. However, in some other embodiments, media items from both the folder 820′ and the folder 828′ can be transferred to the device 804. In these cases, limitations can be added to the transferred media items to avoid unfettered distribution of media items. For example, the system 800 can be configured to limit the amount of times a media item from a different user's media library is transferred to another device. Also, the system 800 can be configured to prompt a user to purchase media items from a different user's library the first time that media item is accessed. If the user declines the purchase, the system 800 can be configured to automatically delete a media item from a different user's library after a certain period of time. Additionally, the system 800 can be configured to enforce versioning controls and only transfer versions of media items with reduced features (e.g. app free versions, demos, etc.)

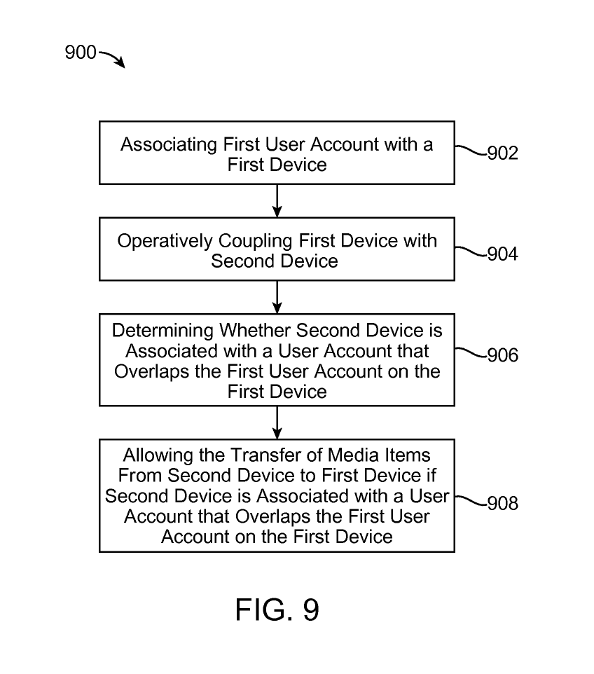

FIG. 9 illustrates a method 900 of transferring media items between a non-home computer and a device associated with a home computer according to some embodiments of present technology. In some embodiments of the present technology, the method 900 involves associating a first user account with a first device (step 902). Next, the method 900 involves operatively coupling the first device with a second device (step 904). Next, the method 900 involves determining whether the second device is associated with a user account that overlaps with a user account on the first device (step 906) by comparing the users accounts to records in a user accounts database and, if the accounts overlap, allowing the transfer of media items from the second device to the first device (step 908).

Some embodiments of the present technology involve associating a first device with a first user account and receiving an authorization from an online media platform to add the media item to the first device. In some embodiments, upon operatively coupling the first device with a second device associated with second user account, the media platform determines if the user account associated with the first device has received an authorization to add any media items in the library associated with the second user account. If so, the authorized media items can be transferred to the first device. In some embodiments, the authorization is only given when a user purchases a media item. In some embodiments, the authorization is only given when a user upgrades from a trial version or demo version to a full version. In some embodiments, the media platform saves a record of the number of times a media item is transfer from a device not associated with the user account and enforces a predetermined threshold number of times the media item can be transferred.

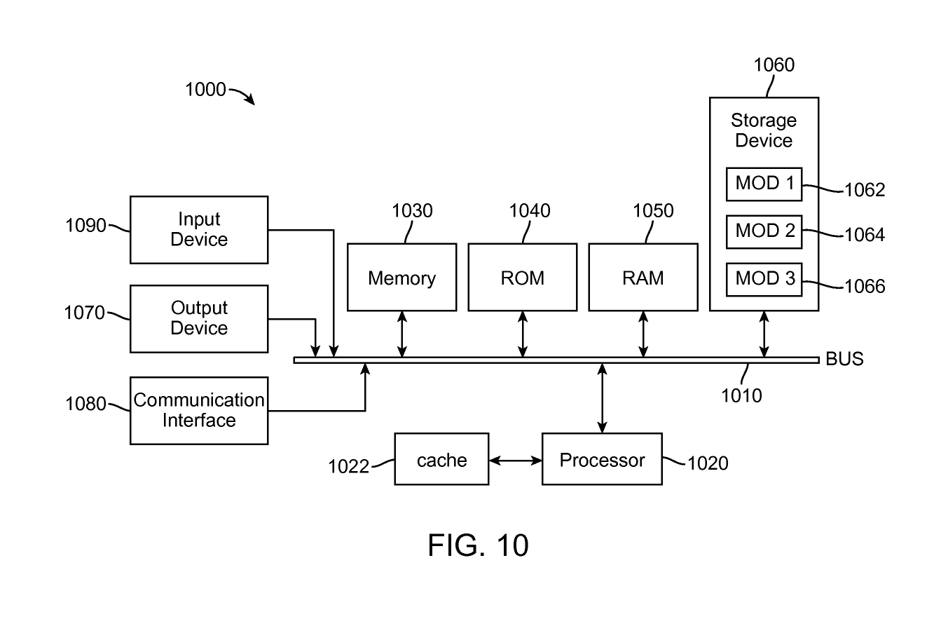

The systems, methods, and computer-readable media described above can be employed in a variety of ways known to those with ordinary skill in the art having the benefit of this disclosure; however, a brief description of a basic general purpose system or computing device in FIG. 10 can provide an example of how to practice the concepts disclosed herein.

FIG. 10 illustrates an exemplary computer system for implementing the present technology according to some embodiments of the present technology. As illustrated in FIG. 10, an exemplary system includes a general-purpose computing device 1000, including a processing unit (CPU or processor) 1020 and a system bus 1010 that couples various system components including the system memory 1030 such as read only memory (ROM) 1040 and random access memory (RAM) 1050 to the processor 1020. The system 1000 can include a cache of high speed memory connected directly with, in close proximity to, or integrated as part of the processor 1020. The system 1000 copies data from the memory 1030 and/or the storage device 1060 to the cache for quick access by the processor 1020. In this way, the cache provides a performance boost that avoids processor 1020 delays while waiting for data. These and other modules can control or be configured to control the processor 1020 to perform various actions. Other system memory 1030 may be available for use as well. The memory 1030 can include multiple different types of memory with different performance characteristics. It can be appreciated that the disclosure may operate on a computing device 1000 with more than one processor 1020 or on a group or cluster of computing devices networked together to provide greater processing capability. The processor 1020 can include any general purpose processor and a hardware module or software module, such as module 1 1062, module 2 1064, and module 3 1066 stored in storage device 1060, configured to control the processor 1020 as well as a special-purpose processor where software instructions are incorporated into the actual processor design. The processor 1020 may essentially be a completely self-contained computing system, containing multiple cores or processors, a bus, memory controller, cache, etc. A multi-core processor may be symmetric or asymmetric.

The system bus 1010 may be any of several types of bus structures including a memory bus or memory controller, a peripheral bus, and a local bus using any of a variety of bus architectures. A basic input/output (BIOS) stored in ROM 1040 or the like, may provide the basic routine that helps to transfer information between elements within the computing device 1000, such as during start-up. The computing device 1000 further includes storage devices 1060 such as a hard disk drive, a magnetic disk drive, an optical disk drive, tape drive or the like. The storage device 1060 can include software modules 1062, 1064, 1066 for controlling the processor 1020. Other hardware or software modules are contemplated. The storage device 1060 is connected to the system bus 1010 by a drive interface. The drives and the associated computer readable storage media provide nonvolatile storage of computer readable instructions, data structures, program modules and other data for the computing device 1000. In one aspect, a hardware module that performs a particular function includes the software component stored in a non-transitory computer-readable medium in connection with the necessary hardware components, such as the processor 1020, bus 1010, display 1070, and so forth, to carry out the function. The basic components are known to those of skill in the art and appropriate variations are contemplated depending on the type of device, such as whether the device 1000 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 1050, read only memory (ROM) 1040, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 1000, an input device 1090 represents any number of input mechanisms, such as a microphone for speech, a touch-sensitive screen for gesture or graphical input, keyboard, mouse, motion input, speech and so forth. An output device 1070 can also be one or more of a number of output mechanisms known to those of skill in the art. In some instances, multimodal systems enable a user to provide multiple types of input to communicate with the computing device 1000. The communications interface 1080 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 1020. The functions these blocks represent may be provided through the use of either shared or dedicated hardware, including, but not limited to, hardware capable of executing software and hardware, such as a processor 1020, that is purpose-built to operate as an equivalent to software executing on a general purpose processor. For example the functions of one or more processors presented in FIG. 10 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 1040 for storing software performing the operations discussed below, and random access memory (RAM) 1050 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 1000 shown in FIG. 10 can practice all or part of the recited methods, can be a part of the recited systems, and/or can operate according to instructions in the recited non-transitory computer-readable storage media. Such logical operations can be implemented as modules configured to control the processor 1020 to perform particular functions according to the programming of the module. For example, FIG. 10 illustrates three modules Mod1 1062, Mod2 1064 and Mod3 1066 which are modules configured to control the processor 1020. These modules may be stored on the storage device 1060 and loaded into RAM 1050 or memory 1030 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

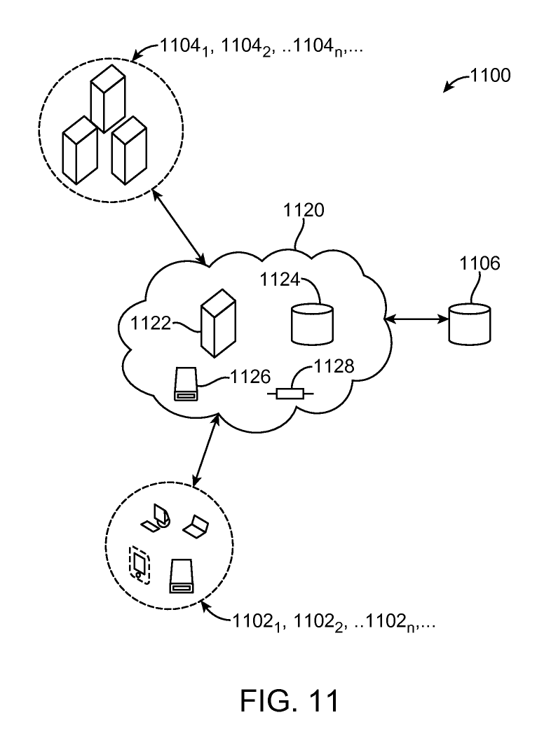

Systems, methods, and computer-readable media configured for the coordination of transferring media items to both user devices and to cloud-based servers for providing cloud-based storage solutions and cloud-based services delivery, such as iCloud®, available from Apple Inc. of Cupertino, Calif. are described above; however, a brief description of a basic cloud computing system can provide an example of how to practice the concepts disclosed herein. FIG. 11 illustrates an exemplary cloud-computing system for implementing the present technology according to some embodiments of the present technology.

Cloud computing is a type of Internet-based computing in which a variety of resources are hosted and/or controlled by an entity and made available by the entity to authorized users via the Internet. An exemplary cloud computing system configuration 1100 is illustrated in FIG. 11 wherein a variety of electronic devices can communicate via a network for purposes of exchanging content and other data. The system can be configured for use on a wide variety of network configurations that facilitate the intercommunication of electronic devices. For example, each of the components of system 1100 in FIG. 11 can be implemented in a localized or distributed fashion in a network.

The system 1100 can be configured to include cloud computing resources 1120 (i.e. “the cloud”). The cloud resources can include a variety of hardware and/or software resources, such as cloud servers 1122, cloud databases 1124, cloud storage 1126, cloud networks 1128, cloud applications, cloud platforms, and/or any other cloud-based resources. In some cases, the cloud resources are distributed. For example, cloud storage 1126 can include multiple storage devices. In some cases, cloud resources can be distributed across multiple cloud computing systems and/or individual network enabled computing devices. For example, cloud computing resources 1120 can communicate with servers 1104₁, 1104₂, . . . , 1104ₙ (collectively “1104”), database 1106, and/or any other network enabled computing device to provide the cloud resources.

Furthermore, in some cases, the cloud resources can be redundant. For example, if cloud computing resources 1120 are configured to provide data backup services, multiple copies of the data can be stored such that the data is still be available to the user even if a storage resource is offline, busy, or otherwise unavailable to process a request. In another example, if the cloud computing resources 1120 are configured to provide software, the software can be available from different cloud servers so that the software can be served from any of the different cloud servers. Algorithms can be applied such that the selection criteria such as the closest server, the server with the lowest current load, or other selection criteria, etc. is used to select a server to process a given request.

In the system 1100, a user interacts with cloud computing resources 1120 through user terminals 1102₁, 1102₂, . . . , 1102ₙ (collectively “1102”) connected to a network by direct and/or indirect communication. Cloud computing resources 1120 can support connections from a variety of different electronic devices, such as servers; desktop computers; mobile computers; handheld communications devices, e.g., mobile phones, smart phones, tablets; set top boxes; network-enabled hard drives; and/or any other network-enabled computing devices, now know or later developed. Furthermore, cloud computing resources 1120 can concurrently accept connections from and interact with multiple electronic devices. Interaction with the multiple electronic devices can be prioritized or occur simultaneously.

Cloud computing resources 1120 can provide cloud resources through a variety of deployment models, such as public, private, community, hybrid, and/or any other cloud deployment model. In some cases, cloud computing resources 1120 can support multiple deployment models. For example, cloud computing resources 1120 can provide one set of resources through a public deployment model and another set of resources through a private deployment model.

In some configurations, a user terminal 1102 can access cloud computing resources 1120 from any location where an Internet connection is available. However, in other cases, cloud computing resources 1120 can be configured to restrict access to certain resources such that a resource can only be accessed from certain locations. For example, if cloud computing resources 1120 are configured to provide a resource using a private deployment model, then cloud computing resources 1120 can restrict access to the resource, such as by requiring that a user terminal 1102 access the resource from behind a firewall.

Cloud computing resources 1120 can provide cloud resources to user terminals 1102 through a variety of service models, such as Software as a Service (SaaS), Platforms as a service (PaaS), Infrastructure as a Service (IaaS), and/or any other cloud service models. In some cases, cloud computing resources 1120 can provide multiple service models to a user terminal 1102. For example, cloud computing resources 1120 can provide both SaaS and IaaS to a user terminal 1102. In some cases, cloud computing resources 1120 can provide different service models to different user terminals 1102. For example, cloud computing resources 1120 can provide SaaS to user terminal 1102₁ and PaaS to user terminal 1102₂.

In some cases, cloud computing resources 1120 can maintain an account database. The account database can store profile information for registered users. The profile information can include resource access rights, such as software the user is permitted to use, maximum storage space, etc. The profile information can also include usage information, such as computing resources consumed, data storage location, security settings, personal configuration settings, etc. In some cases, the account database can reside on a database or server remote to cloud computing resources 1120 such as servers 1104 or database 1106.

Cloud computing resources 1120 can provide a variety of functionality that requires user interaction. Accordingly, a user interface (UI) can be provided for communicating with cloud computing resources 1120 and/or performing tasks associated with the cloud resources. The UI can be accessed via an end user terminal 1102 in communication with cloud computing resources 1120. The UI can be configured to operate in a variety of client modes, including a fat client mode, a thin client mode, or a hybrid client mode, depending on the storage and processing capabilities of cloud computing resources 1120 and/or the user terminal 1102. Therefore, a UI can be implemented as a standalone application operating at the user terminal in some embodiments. In other embodiments, a web browser-based portal can be used to provide the UI. Any other configuration to access cloud computing resources 1120 can also be used in the various embodiments.

As described above, in some configurations, the cloud computing resources can be used to store user data. The present disclosure contemplates that, in some instances, this gathered data might include personal and/or sensitive data. The present disclosure further contemplates that the entities responsible for the collection, analysis, disclosure, transfer, storage, or other use of such data should implement and consistently use privacy policies and practices that are generally recognized meeting or exceeding industry or governmental requirements for maintaining personal information data private and secure. For example, personal data from users should be collected for legitimate and reasonable uses of the entity and not shared or sold outside of those legitimate uses. Further, such collection should occur only after the informed consent of the users. Additionally, such entities should take any needed steps for safeguarding and securing access to such personal data and ensuring that others with access to the personal data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal data. That is, the present disclosure contemplates that hardware and/or software elements can be provided to prevent or block access to such personal data. For example, the present technology can be configured to allow users to select the data that is stored in cloud storage. In another example, the present technology can also be configured to allow a user to specify the data stored in cloud storage that can be shared with other users.

Therefore, although the present disclosure broadly covers use of personal data to implement one or more various disclosed embodiments, the present disclosure also contemplates that the various embodiments can also be implemented without the need for accessing such personal data. That is, the various embodiments of the present technology are not rendered inoperable due to the lack of all or a portion of such personal data. For example, non-personal data can be stored in cloud storage.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method of transferring media comprising:
obtaining a list of media items stored at a first device and that are available to transfer to a second device upon the first device being operatively coupled with the second device, wherein the second device is associated with a user account;
determining, via a processor, which of the media items in the list are not available for re-download from another source associated with the user account to yield a list of media items that are not available for re-download; and
sending the list of media items not available for re-download to the second device as media items available for sync from the first device.

2. The method of claim 1, wherein determining which of the media items in the list are not available for re-download from another source comprises:
comparing media items stored on the first device with media items stored in an online storage component configured for storing media items associated with a user account; and
receiving a list of media items that are stored on the first device, but not in the online storage component.

3. The method of claim 2, wherein determining which media items are not available for re-download further comprises:
determining if media items on the list of media items that are stored on the first device, but not in the online storage component comply with a digital rights management policy selected from among a re-downloading policy, a streaming policy, and a re-downloading and streaming policy.

4. The method of claim 3, further comprising:
consulting a digital rights management server to determine if media items on the list of media items that are stored on the first device, but not in the online storage component comply with digital rights management policy.

5. The method of claim 3, further comprising:
consulting a database to determine if media items on the list of media items that are stored on the first device, but not in the online storage component comply with digital rights management policy.

6. The method of claim 3, further comprising receiving a list of re-downloadable media items on the list of media items that are stored on the first device, but not in the online storage component that comply with the digital rights management policy.

7. The method of claim 6, further comprising storing media items on the list of re-downloadable media items in the online storage component.

8. The method of claim 1, wherein sending the list of media items not available for re-download to the second device as media items available for sync from the first device further comprises syncing media items not on the list of re-downloadable media items onto the second device.

9. The method of claim 1, further comprising:
determining if the client application associated with a user account tied to a home computer; and wherein sending the list of media items not available for re-download to the second device as media items available for sync from the first device further comprises not syncing media items to the second device if the second device is not the home computer.

10. A system comprising:
a media distribution and management server configured for distributing media items to a client device associated with a user account, the media distribution and management server further configured with a cloud storage component configured for storing media items associated with the user account;
a first client device containing media items;
a second client device having a media distribution and management client application associated with one or more user account, wherein the media distribution and management server is further configured to:
obtain a list of media items stored at a first device and that are available to transfer to a second device upon the first device being operatively coupled with the second device, wherein the second device is associated with a user account;
determine, via a processor, which of the media items in the list are not available for re-download from the cloud storage component to yield a list of media items that are not available for re-download; and
send the list of media items not available for re-download to the second device as media items available for sync from the first device.

11. The system of claim 10, wherein the media distribution and management server is further configured to:
determine if media items on the list of media items that are stored on the first device, but not in the online storage component comply with a digital rights management policy selected from among a re-downloading policy, a streaming policy, and a re-downloading and streaming policy.

12. The system of claim 11, wherein the media distribution and management server is further configured to:
consult a digital rights management server, a database, or a digital rights management server and a database to determine if media items on the list of media items that are stored on the first device, but not in the online storage component comply with digital rights management policy.

13. The system of claim 11, wherein the media distribution and management server is further configured to:
store re-downloadable media items on the list of media items that are stored on the first device, but not in the online storage component that comply with the digital rights management policy in the online storage component.

14. The system of claim 11, wherein the first device is further configured to sync media items not on the list of re-downloadable media items onto the second device.

15. A non-transitory computer-readable medium comprising:
a medium configured to store computer-readable instructions thereon; and
the computer-readable instructions that, when executed by a processing device cause the processing device to perform a method, comprising:
receiving a list of media items that might need to be synced from a first device to a second device upon the first device being operatively coupled with the second device;
determining which media items are not available for re-download; and
transmitting a list of media items to sync with the second device which are not available for re-download.

16. The non-transitory computer-readable medium of claim 15,
wherein the processing device further comprises an online storage component configured for storing media items associated with a user account,
wherein the processing device comprises a media distribution and management system configured for distributing media items to a client device associated with a user account,
wherein the second device comprises a computer having a client application associated with one or more user account,
wherein receiving a list of media items that might need to be synced from a first device to a second device upon the first device being operatively coupled with the second device further comprises comparing media items stored on the first device with media items stored in the online storage component and receiving a list of media items that are stored on the first device, but not in the online storage component.

17. A method of transferring media from a first device to a second device comprising:
receiving, by the second device, a request by a first device to transfer a media item from the first device to the second device, wherein each of the first device and the second device are associated with a set of one or more user accounts, and wherein the set of user accounts for the first device and the second device are different;
determining by the second device if an overlap exists between the set of user accounts for the first device and the set of user accounts for the second device; and transferring the media item to the first device if the overlap exists.

18. The method of claim 17, wherein the request to transfer a media item from a first device to a second device is received automatically upon the first device being operatively coupled with the second device.

19. The method of claim 17, wherein determining an overlap exists comprises:
examining a first media library associated with a media player client application on the first device;
examining a second media library associated with a media player client application on the second device; and
determining if the first media library and the second media library share common user account library folders.

20. A system comprising:
a first device containing a media player client application associated with a first account;
a second device containing a media player client application associated with a second account, wherein the second device is configured to:
receive a request by a first device to transfer a media item from the first device to the second device, wherein each of the first device and the second device are associated with a set of one or more user accounts, and wherein the set of user accounts for the first device and the second device are different;
determine if an overlap exists between the set of user accounts for the first device and the set of user accounts for the second device; and
transferring the media item to the first device if the overlap exists.

21. The system of claim 20, wherein the request to transfer a media item from a first device to a second device is received automatically upon the first device being operatively coupled with the second device.

22. The system of claim 20, wherein, in order to determine that an overlap exists, the second device is further configured to:
examine a first media library associated with a media player client application on the first device;
examine a second media library associated with a media player client application on the second device; and
determine if the first media library and the second media library share common user account library folders.

23. A non-transitory computer-readable medium comprising:
a medium configured to store computer-readable instructions thereon; and
the computer-readable instructions that, when executed by a processing device cause the processing device to perform a method, comprising:
receiving, by the second device, a request by a first device to transfer a media item from the first device to the second device, wherein each of the first device and the second device are associated with a set of one or more user accounts, and wherein the set of user accounts for the first device and the second device are different;
determining by the second device if an overlap exists between the set of user accounts for the first device and the set of user accounts for the second device; and
transferring the media item to the first device if the overlap exists.

24. A method for transferring media onto a device comprising:
associating a first device with a first user account;
operatively coupling the first device with a second device associated with second user account, the second user account associated with a media library containing a media item;
receiving an authorization from an online media platform to add the media item to the first device; and
accepting the transfer of a copy of the media item to the first device from the media library of the second device.

25. The method of claim 24, further comprising:
receiving a request from a client device associated with the first user account to download the media item from the online media platform;
fulfilling the request by allowing the download of the media item to the client device; and
saving a record in a database on the media platform that client devices associated with the first user account are authorized to add the media item to client devices associated with the first user account from client devices not associated with the first account.

26. The method of claim 25, wherein fulfilling the request comprises determining that the first user account indicates that the media item was purchased.

27. The method of claim 25, wherein the media item is first version of a media item, the method further comprising:
prompting the client device with an option to upgrade to a second version of the media item, wherein upgrading to a second version of the media item is required before saving a record in a database on the media platform that client devices associated with the first user account are authorized to add the media item to client devices associated with the first user account from client devices not associated with the first account.

28. The method of claim 24, further comprising:
associating a counter in the first user account upon accepting the transfer of a copy of the media item to the first device from the media library of the second device.

29. The method of claim 28, further comprising:
incrementing the counter in the first user account upon successively accepting the transfer of a copy of the media item to the first device from the media library of another device.

30. The method of claim 29, further comprising:
denying the transfer of a copy of the media item to the first device from the media library of another device upon a client device associated with the first user account with a counter value in excess of a predetermined threshold upon the client device attempting to transfer of a copy of the media item to the first device from the media library of the second device.
